(19) United States
(12) Patent Application Publication
(10) Pub. No.: US 2014/0091129 A1
(43) Pub. Date: Apr. 3, 2014

(54) SELF-LEVELING WELDING TRACTOR

(71) Applicant: LINCOLN GLOBAL, INC., City of Industry, CA (US)

(72) Inventors: Steven R. Peters, Huntsburg, OH (US); Edward A. Enyedy, Eastlake, OH (US)

(73) Assignee: LINCOLN GLOBAL, INC., City of Industry, CA (US)

(21) Appl. No.: 13/629,818

(22) Filed: Sep. 28, 2012

(51) Int. Cl. B23K 3/00; B23K 31/02

(52) U.S. Cl. 228/102; 228/33; 228/8

(57) ABSTRACT

A welding tractor is described as well as a process for using the tractor in which a predefined angle of inclination or declination is maintained during a circumferential welding process.

### TECHNICAL FIELD

The present disclosure is related to a welding system, and more particularly, to products, methods, and systems to remotely circumferentially weld cylindrical joints of objects during rotation.

### BACKGROUND OF INVENTION

Cylindrical objects often require welds on their interior or exterior circumference. Such cylindrical objects, for example, include pipes, tanks, and the like. Welds are used, for example, to connect two cylindrical objects, seal a cylindrical object, repair a cylindrical object, apply cladding and the like. It is common that remote welding tractors are used within the confined interior space or upon exterior locations of a cylindrical object. To complete a weld, welding tractors travel about the circumference of the cylindrical object. To keep these tractors in contact with the surface of the cylindrical object, the cylindrical object is often rotated about its longitudinal axis. Therefore, the welding tractor maintains its original location in relation to the cylindrical object by moving in the opposite direction and at the same speed as the rotation of the cylindrical object.

Often the cylindrical object is supported and stabilized by two rollers at its base. These rollers rotate forcing the cylindrical object to rotate in the opposite direction. Friction between the rollers and the cylindrical object keep the cylindrical object in motion. To rotate the cylindrical object, the rollers begin rotating from a stopped position. Therefore, the rollers and cylindrical objects rotate at variable speeds. These variable speeds can be experienced before, during, and after welding operations.

In current applications, the welding tractor, which is typically positioned within the cylindrical object before rotation begins, is manually controlled to maintain the correct position. This manual control requires an operator to constantly watch the system and immediately react when changes in the rotational speed of the rollers or the cylindrical object occur. A change in rotation can cause the welding tractor to upset or unsteadily rock from its position on the cylindrical object. Moreover, this may results in unsatisfactory or incomplete welds. In view of these and other deficiencies products, methods, and systems are needed to self-level a welding tractor on or within a cylindrical object during welding operations.

### SUMMARY OF THE INVENTION

To remotely circumferentially weld a cylindrical object, a welding tractor may be positioned within or on top of a cylindrical object. The welding tractor includes a base. In operative association with the base is a welding assembly, a wire reel assembly, a level sensor, a motor, and wheels. The wire reel assembly supplies welding wire to the welding assembly. The welding assembly welds the cylindrical object. The level sensor determines the levelness of the welding tractor in association with the cylindrical object. This levelness is communicated by the level sensor to a controller. This controller is located in operative association to the base of the welding tractor or in a remote location. This controller uses the angle of inclination or declination of the welding tractor to operate the motor to maintain said angle as close to 0° as possible using the degree of mechanical sophistication normally associated with circumferential welding equipment. The motor drives the wheels rotatably connected to the base of the welding tractor. The wheels are positioned on the base so to support the welding tractor and each of its components above the surface of the cylindrical object. Further, the wheels are each facing the same direction moving the welding tractor in a forward direction.

To travel the entire circumference of the cylindrical object a means for rotating the at least one cylindrical object is applied. One example includes supporting and stabilizing a cylindrical object by placing the cylindrical object upon rollers. Friction between the rollers and the cylindrical object force the cylindrical object to rotate in the opposite direction. As the cylindrical object rotates, the aforementioned welding tractor remains stationary and circumferentially welds the inside of the cylindrical object. To maintain the position of the welding tractor, the forward moving speed of said welding tractor varies as the rotational speed of the rollers and the cylindrical object vary.

In one aspect, a level sensor communicates the levelness of the welding tractor to a controller located on the welding tractor. The controller adjusts the speed of the welding tractor maintaining the position of the welding tractor. As this welding tractor maintains its position, the cylindrical object rotates beneath the welding tractor. The controller adjusts the speed of the welding tractor as the cylindrical object's rotational speed varies.

In another aspect, a level sensor communicates the position the welding tractor to a controller located remotely and communicating with the level sensor and the motor through either a cable or wireless protocol. The controller may be one of a tablet, a cellular phone, a global positioning system and a laptop computer. Using a wireless protocol, the controller maintains the desired speed of the welding tractor by operating the motor thus driving the wheels.

This brief description is provided to introduce a selection of concepts in a simplified form that are further described herein. This brief description is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Reference is made to the accompanying drawings in which particular embodiments and further benefits of the invention are illustrated as described in more detail in the description below, in which:

FIG. 1 is a perspective view of a four-wheeled self-leveling welding tractor within a cylindrical object which is supported, stabilized, and rotated by rollers;

FIG. 2 is a perspective view similar to FIG. 1, illustrating an articulating arm operatively attached to a welding tractor and extending a welding assembly in front of and above said welding tractor;

FIG. 3 is a perspective view similar to FIG. 1, illustrating a welding tractor on the exterior of a cylindrical object for circumferentially welding the outside of said cylindrical object;

FIG. 4 is a perspective view similar to FIG. 1, illustrating a three-wheeled welding tractor with a global positioning device and a reference point as an alternative to a level sensor.

FIG. 5 is a perspective view similar to FIG. 1, illustrating the level sensor, motor, and controller are in operative association with the base of the welding tractor;

FIG. 6 is a perspective view similar to FIG. 1, additionally illustrating a remotely located controller communicating to the level sensor and motor via a cable; and

FIG. 7 is a perspective view similar to FIG. 1, further illustrating a remotely located controller communicating to the level sensor and motor via a wireless protocol.

### DETAILED DESCRIPTION OF THE INVENTION

Referring now to the figures, several embodiments or implementations of the present invention are hereinafter described in conjunction with the drawings, wherein like reference numerals are used to refer to like elements throughout. The present disclosure is related to a self-leveling welding tractor for welding about the circumference of a cylindrical object. Although illustrated and described hereinafter in the context of various exemplary welding products, methods, and systems, the invention is not limited to the illustrated examples.

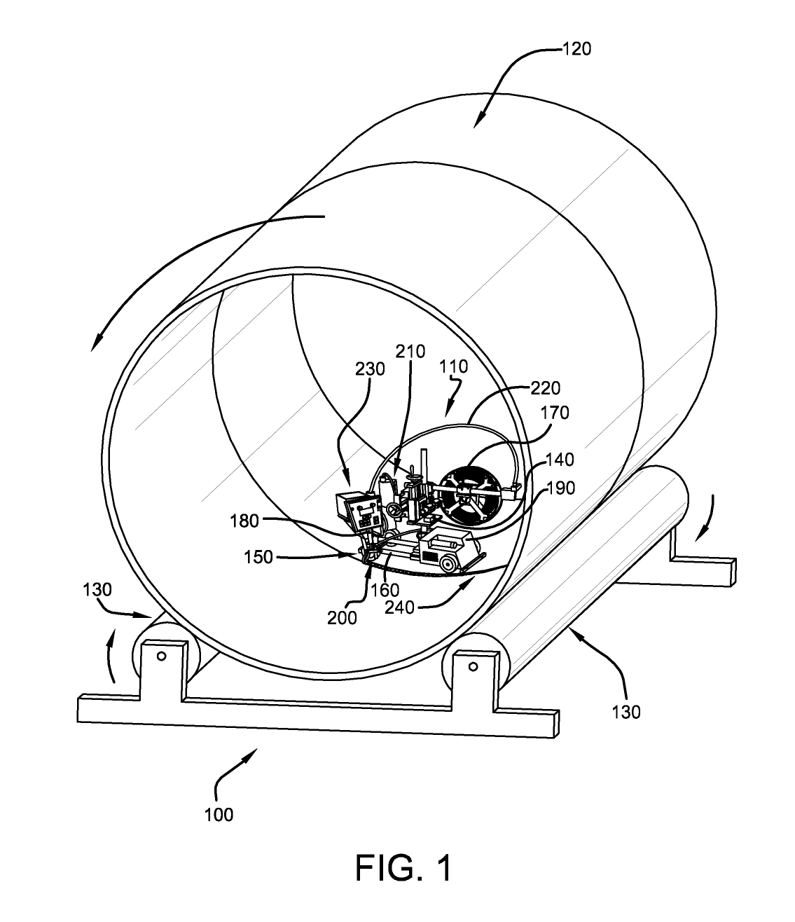

FIG. 1 illustrates welding system 100, which includes welding tractor 110 at least partially within at least one cylindrical object 120. Cylindrical object 120 is being supported and stabilized by at least two rollers 130. Welding tractor 110 is located in a forward moving position wherein welding tractor 110 remains stationary as cylindrical object 120 rotates about its longitudinal axis as welding system 100 is in rotational motion. Thus, the forward direction of welding tractor 110 is opposite the rotation of cylindrical object 120 when welding system 100 is rotating. Likewise, the rotation of cylindrical object 120 will rotate the opposite direction of at least two rollers 130 when welding system 100 is in operation.

Welding tractor 110 includes base 150, welding assembly 160, wire reel assembly 170, level sensor 140, motor 190 and at least two wheels 200. Welding assembly 160 applies weld 240 to cylindrical object 120. Wire reel assembly 170 supplies welding wire 220 to welding assembly 160. As illustrated in FIG. 1 and when the type of welding employed utilizes submerged arc welding, flux feeder 180 may be operatively associated with base 150 and supply flux 230 to weld 240. Alternatively, welding tractor 110 may accommodate other types of welding.

Level sensor 140 identifies and communicates the degree of horizontal planarity of welding tractor 110 to controller 210. Controller 210 may be in operative association with the base 150 or in a remote location wherein controller 210 is, for example, a tablet, a cellular phone, a global positioning system, or a laptop computer. Controller 210 further communicates with and operates motor 190 through a wire or wireless interface. Controller 210 operates motor 190 in response to the welding tractor's 110 levelness communicated to controller 210 by level sensor 140. Motor 190 drives at least one wheel 200 forcing welding tractor 110 forward thus maintaining a levelness of the welding tractor 110 as cylindrical object 120 rotates in the opposite direction. Concurrently or on demand, weld reel assembly 170 supplies welding wire 220 to welding assembly 160, and welding assembly 160 applies weld 240 to cylindrical object 120.

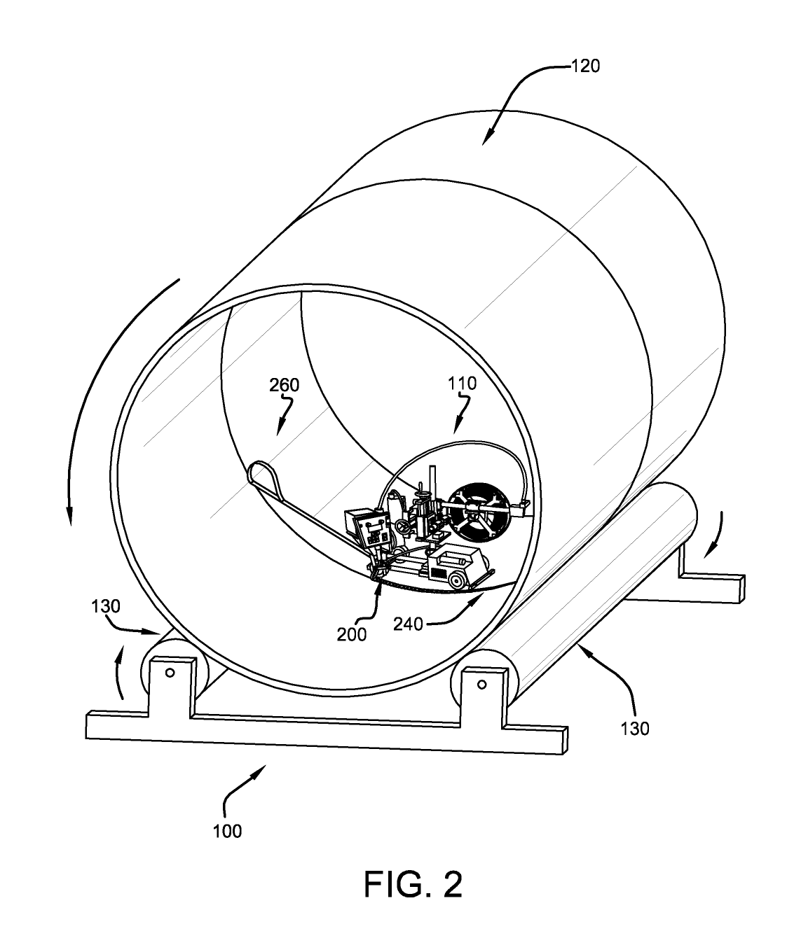

FIG. 1 illustrates welding assembly's 160 location to be within the perimeter of base 150 of welding tractor 110. In the alternative, FIG. 2 illustrates welding assembly 160 attached to articulating arm 260 operatively associated with welding tractor 110 at the opposite end. Articulating arm 260 may extend welding assembly 160 to locations on the circumference of cylindrical object 120 including the front, rear, side, above or below the current position of welding tractor 110.

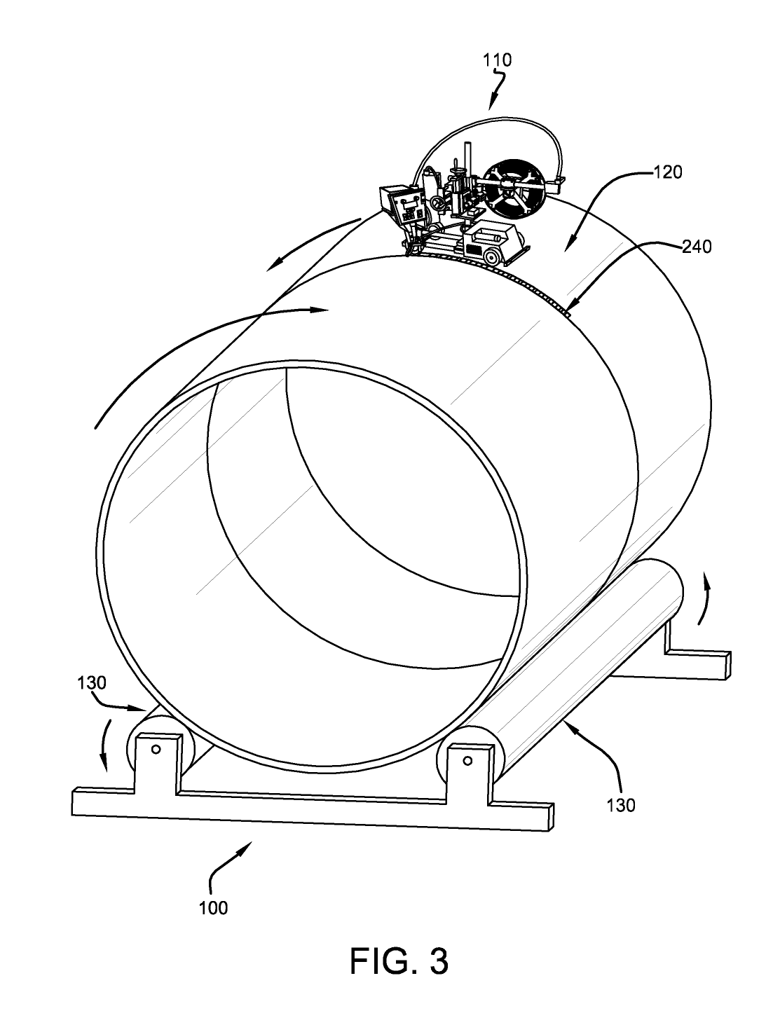

In this example, welding tractor 110 is at least partially placed inside cylindrical object 120. In the alternative, FIG. 3 illustrates welding tractor 110 may be at least partially placed on the exterior of cylindrical object 120 for circumferentially welding the outside of cylindrical object 120. Welding tractor 110 is located in a forward moving position wherein said welding tractor 110 remains stationary about the top of cylindrical object 120 as cylindrical object 120 rotates about its longitudinal axis and as welding system 100 is in motion.

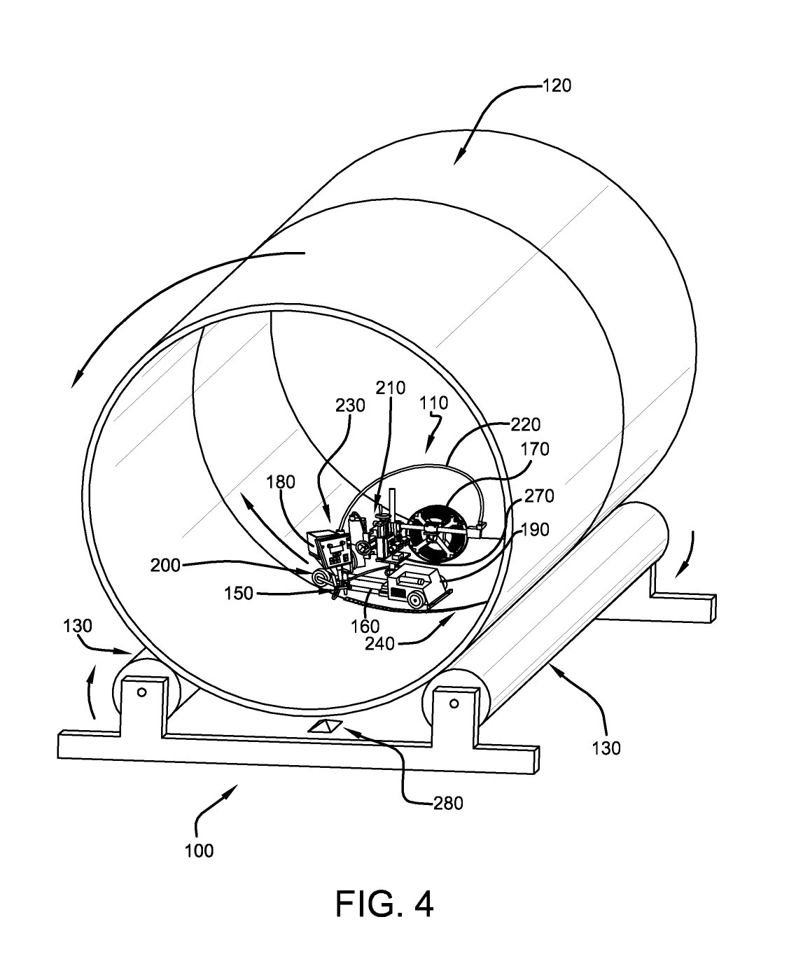

As illustrated in FIG. 1, in operative association with base 150 of welding tractor 110 is level sensor 140. Level sensor 140 communicates the degree of horizontal planarity of welding tractor 110 to controller 210. Level sensor 140 may be a bubble level, electronic level, digital level, and the like. Level sensor 140 is in operative association with base 150. Level sensor 140 identifies the degree of horizontal planarity of welding tractor 110 through gravitational forces. Controller 210 communicates and operates motor 190 to maintaining level sensor's 140 horizontal position thus maintaining welding tractor's 110 degree of horizontal planarity relative to a rotating cylindrical object 120. In the alternative, FIG. 4 illustrates level sensor 140 may be replaced with global positioning device 270. Such a device communicates the welding tractor's position to controller 210 relative to any reference point 280 adjacent to the cylindrical object 120 as cylindrical object 120 rotates.

As additionally illustrated in FIG. 1, the rotating means of cylindrical object 120 includes at least two parallel rollers 130 on which cylindrical object 120 is placed. Rollers 130 secure, stabilize and rotate cylindrical object 120. In this example, rollers 130 are positioned opposite one another at a location below the horizontal centerline of cylindrical object 120. The distance between rollers 130 is less than the diameter of cylindrical object 120. Cylindrical object 120 is placed on rollers 130 to allow cylindrical object 120 to rotate about its longitudinal axis. Force is applied to at least one roller 130 thereby rotating it about its longitudinal axis. Friction between roller 130 and cylindrical object 120 forces cylindrical object 120 to rotate about its longitudinal axis in the opposite direction as the rotation of roller 130. Alternative means for rotating at least one cylindrical object 120 further include a structure rotatably securing the cylindrical object 120 from above, through its center, or about its circumference.

Another embodiment for welding a cylindrical object 120 includes placing an oval object on at least two rollers 130 positioned below the horizontal centerline of the oval object. Rollers 130 are positioned apart a distance less than the shortest axis of symmetry of the oval object. Additional rollers 130 can be used to further stabilize an oval object.

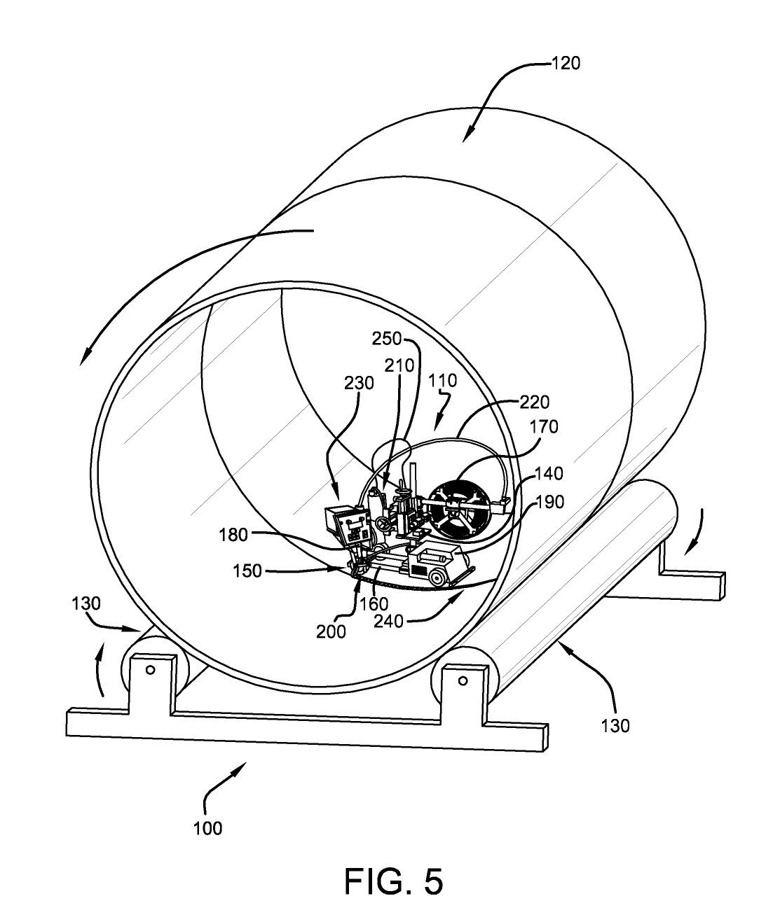

FIG. 5 illustrates welding system 100, wherein controller 210 is in operative association with base 150. Controller 210 communicates to level sensor 140 and motor 190 wherein the level sensor and motor may operatively interface to the controller via wired or wireless means. The level sensor 140 and motor 190 are capable of being operatively connected to controller 210 via cable 250. Cable 250 may be an Ethernet cable, data cable, fiber optics cable, etc.

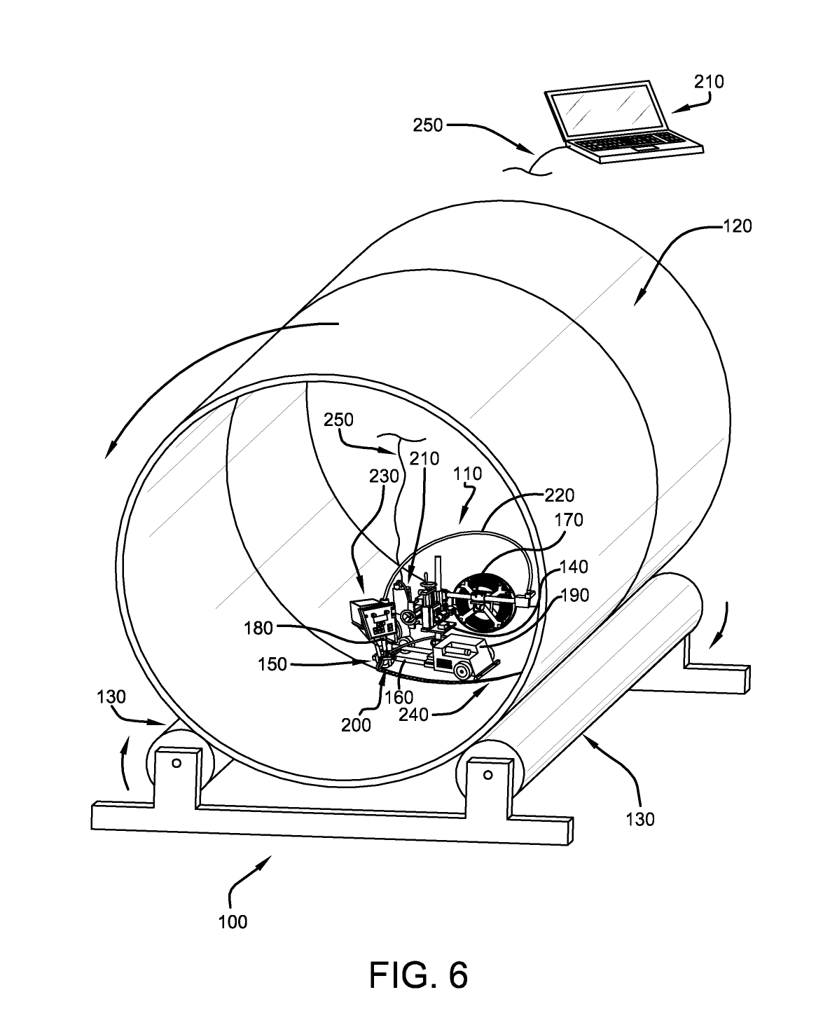

FIG. 6 illustrates welding system 100, wherein controller 210 is remotely located from base 150 but is connected to and operatively interfaces with level sensor 140 and motor 190 via wired means. The level sensor 140 and the motor 190 is capable of being operatively connected to the controller via cable 250 which can be an Ethernet cable, a data cable, a fiber optic cable or any other suitable hardwire means.

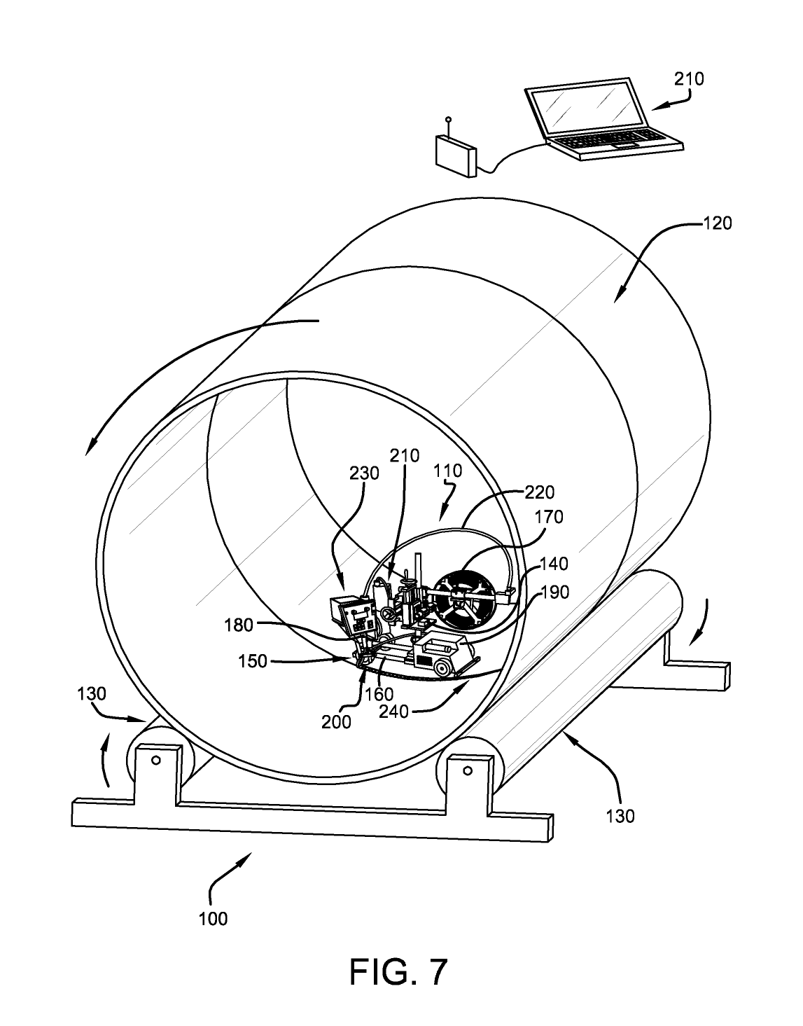

FIG. 7 illustrates welding system 100, wherein controller 210 is remotely located from base 150 and controller 210 communicates with level sensor 140 and motor 190 using wireless means via a wireless protocol. Methods of wireless protocol include Wi-Fi enablement, wireless Bluetooth™ communication, Firewire™ communication or any other suitable wireless communication means.

While the focus of the previous discussion has been on monitoring the position of welding tractor 110 in a level or horizontal position, the invention is not limited to the above. Rather the invention encompasses monitoring welding tractor 110 at a predefined angle of inclination or declination, and holding this angle essentially constant during the circumferential welding process. In a preferred embodiment the predefined angle is 0°, although both positive and negative angles from horizontal are within the scope of this invention, varying at least between +30° to −30° from horizontal, but within the confines of sound engineering judgment.

In practicing the process of the invention, a method for circumferentially welding at least one cylindrical object is described in which at least the following steps are employed: inserting a welding tractor into a cylindrical object for performing a circumferential welding operation, the welding tractor comprising a base, a welding assembly in operative associated with the base, a wire reel assembly in operative associated with the base for supplying welding wire to the welding assembly, and a level sensor in operative association with the base for determining the angle of inclination or declination of the welding tractor; rotating the cylindrical object about its longitudinal axis; continuously monitoring the angle of inclination or declination of the welding tractor; and generating a signal proportional to the magnitude of said angle of inclination or declination of said welding tractor; interfacing said signal with at least one drive wheel on said welding tractor to control a speed of said at least one drive wheel responsive to said signal to maintain said speed of said welding tractor so that said angle of inclination or declination is essentially 0°. The step of interfacing is often wireless.

There are instances when the angle of inclination or declination is sought to be maintained at a predefined angle, which may vary from +30° and −30° with respect to a horizontal plane. In this instance, the angle of inclination or declination of the welding tractor is continuously monitored, and a signal is generated proportional to the magnitude of the difference between the angle of inclination or declination of the welding tractor and the predefined angle. The signal is interfaced with at least one drive wheel on the welding tractor to control the speed of said at least one drive wheel responsive to the signal to maintain the speed of the welding tractor so that the difference between the angle of inclination or declination and the predefined angle is essentially 0°.

While the above discuss has focused on proportionately matching the rotational speed of the pipe to the rotational speed of the welding tractor wheels, the invention is not limited to such. In fact, in an alternative embodiment, powered cross slides are employed in place of wheels and the angle of the torch and/or position of the welding tractor positioned on a cross slide is controlled by communication with a level sensor positioned directly (or indirectly) within the pipe. The communication is either wired or wireless as discussed hereinabove.

In a preferred embodiment, controller is a PID controller (Proportional Integral Derivative controller). Proportional means that there is a linear relationship between two variables. Proportional control is an excellent first step, and will reduce, but never eliminate, the steady-state error and typically results in an overshoot error. To improve the response of a proportional controller, integral control is often added. The integral is the running sum of the error. Therefore, the proportional controller tries to correct the current error and the integral controller attempts to correct and compensate for past errors. The derivative controller attempts to predictively correct error into the future. That means that the error is expected to be the current error plus the change in the error between the two preceding sensor sample values. The change in the error between two consecutive values is the derivative. While a PID controller is preferred, the system will benefit from the use of just a proportional controller, a proportional-integral controller, or a proportional-derivative controller.

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

1. A welding tractor for circumferentially welding an object rotatable about its longitudinal axis, comprising:
a base;
a welding assembly in operative association with the base;
a source of welding wire for supplying welding wire to the welding assembly; and
a level sensor in operative association with the base for determining the angle of inclination or declination of the welding tractor.

2. The welding tractor of claim 1 further comprising:
at least two wheels rotatably connected to the base;
at least one of said wheels being a drive wheel; and
a means for controlling a speed of said at least one drive wheel responsive to a signal generated by said level sensor upon said angle of inclination or declination being greater than or less than essentially 0°.

3. The welding tractor of claim 2 wherein
said means for controlling is a PID controller.

4. The welding tractor of claim 2 wherein
the means for controlling is in wireless communication with the level sensor and the motor.

5. A welding tractor for circumferentially welding an object rotatable about its longitudinal axis, comprising:
a base;
a welding assembly in operative association with the base;
a source of welding wire for supplying welding wire to the welding assembly; and
a sensor in operative association with the base for determining the angle of inclination or declination of the welding tractor.

6. The welding tractor of claim 5 further comprising:
at least two wheels rotatably connected to the base;
at least one of said wheels being a drive wheel; and
a means for controlling a speed of said at least one drive wheel responsive to a signal generated by said level sensor upon said angle of inclination or declination being greater than or less than a predefined angle of inclination or declination.

7. The welding tractor of claim 6 wherein
said means for controlling is a PID controller.

8. The welding tractor of claim 5 wherein
the means for controlling is in wireless communication with the level sensor and the motor.

9. (canceled)

10. (canceled)

11. (canceled)

12. (canceled)

13. A welding system for maintaining the angle of inclination or declination of a welding tractor in association with at least one cylindrical object rotating about its longitudinal axis, comprising:
a welding tractor comprising:
a base,
a welding assembly operatively associated with the base,
a source of welding wire for supplying welding wire to the welding assembly,
a level sensor operatively associated with the base for determining the position of the welding tractor relative to the bottom of the cylindrical object,
at least two wheels connected to the base for supporting the welding tractor above the surface of the cylindrical object, and
a motor operatively associated with the base for rotatably driving at least one wheel;
a controller associated with the welding tractor in communication with the level sensor and the motor, wherein the controller operates the motor to maintain a predefined angle of inclination or declination of the welding tractor in response to the level sensor communicating said angle to a comparator;
means for rotating the at least one cylindrical object about its longitudinal axis.

14. The welding system of claim 13 wherein
the predefined angle of inclination or declination is between +30° and −30° with respect to a horizontal plane.

15. The welding system of claim 14 wherein
the predefined angle if inclination or declination is approximately 0°.

16. The welding system of claim 13 wherein
the controller is remotely located from the welding tractor for operating the motor.

17. The welding system of claim 16 wherein
the controller communicates wirelessly with the level sensor and the motor.

18. (canceled)

19. (canceled)
